(19) United States
(12) Patent Application Publication
(10) Pub. No.: US 2009/0301822 A1
(43) Pub. Date: Dec. 10, 2009

(54) Cable hanging system

(76) Inventor: Laszlo Keszthelyi, Queens, NY (US)

Correspondence Address: Miskin & Tsui-Yip LLP, 1350 Broadway, Suite 802, NEW YORK, NY, 10018, US

(21) Appl. No.: 12/156,868

(22) Filed: Jun. 5, 2008

(51) Int. Cl. B66B 7/06; B23P 11/00

(52) U.S. Cl. 187/413; 29/525.01

(57) ABSTRACT

A cable hanging system that relieves tension and provides a mounting point for multi conductor electrical cable used in vertical transport industry includes a base, a first disk, a second disk, a first pin, a second pin, and a third pin. The base, first disk, and second disk have apertures that correspond to the first pin, second pin and third pin that allow the first disk and the second disk to be attached to the base. The first disk has a circumferential channel that allows the steel cable with the multi conductor electrical cable wrapped around it to be wedged therein. The first disk further has a cutout for the steel cable to exit the channel and be placed between the first pin and second pin. The steel cable is then strung over the second pin and in between the second pin and the third pin. The second disk is stacked on the first disk and holds the cable hanging system together.

### FIELD OF THE INVENTION

The invention relates to a device for mounting a multi conductor electrical cable commonly used in the vertical transport industry. In particular, an improved mounting device that relieves tension and distributes stress over a large area maximizing the cable's lifetime and strength. This also allows for quick installation time and for ease of installation and adjustment of the cable location.

### BACKGROUND OF THE INVENTION

Mounting devices for a multi conductor electrical cable are commonly used in the vertical transport industry. Various switches and communications are necessary between the moveable device, typically the elevator car, and a fixed point, typically the shaft way junction box. The multi conductor electrical cable serves as the sole communication for the elevator car and has transmission media for supplying electricity to the elevator car, transmitting signals from the elevator car to the controller for the proper selection of floors, and to supply audio video and or AC supply to the car. Elevator cable hangers are used to attach the multi conductor electrical cable to the elevator car, which is the attachment point for one end of the cable, and the attachment point for the other end of the cable to a fixed point in the shaft way. The traditional practice has been to secure the cable hanger immediately below a junction box in the mid-point of the elevator shaft way. The prior art teaches different methods of attaching the cable to the elevator car, the fixed point in the shaft way or in the motor room. Three standard prior art methods of attachment include the use of steel core hanging devices, steel support wire clamps and wire mesh grips.

When a steel core hanging device is used, a strength member hanger is used to secure a central strength member, normally a wire rope of the cable. The strength member support is mounted at the top of a bracket, which is bolted to a structural member or other secure location in the shaft way or on the elevator car. The rest of the traveling cable is suspended from the strength member hanger. The prior art has taught for the block of wood with a carved out indentation corresponding to the shape of the cable outer jacket. A metal clamp is then placed over the cable and attached by screws or the like to the wood block. An optional additional wood block having a carved out section corresponding to the first wood block is used to secure the cable.

The wood block secures one end of the cable from excessive swaying during movement of the elevator car. However, the rough, carved, wood block causes excessive wear to the cable's outer jacket. In addition, the clamping device allows the cable to rotate, which also causes wear to the cable. Further, if the bracket is secured too tightly, the cable is compressed and will cause damage to the wires and communication elements in the cable.

Another cable hanger known in the prior art is a steel support clamp device described in U.S. Pat. No. 5,080,199 which grips and supports the steel wire support member. It contains stainless steel hose clamps to keep the cable from twisting and a curved bracket to cradle the cable. Further, the bracket contains a steel bracket with welded steel support to bear the cable weight along with a strand vise which firmly secures the steel central support cable. However, this construction has many disadvantages, such as allowing the cable to be twisted and get caught. Further the strand vise can bust when the elevator car causes a jerking action. If the cable does not hang in a proper manner, it can become twisted, caught on shaft way objects and be damaged to the point of failure, causing the entire system to shut down. The installation process on this device is very lengthy and requires many hours, possibly days, of installation. None of the prior art devices allow rotational adjustment of the cable after mounting.

Therefore, there is a need for a simple cable hanging system that effectively relieves tension and rotation of the cable without the need for complicated or lengthy installation or maintenance and allows easy adjustment of the cable after mounting.

### SUMMARY OF THE INVENTION

The present invention provides a cable hanging system that relieves tension on a cable, and allows easy and efficient installation wherein one person can install and adjust rotational tension. Further, the cable mounting system can accommodate most commonly found sized cables in a manner that distributes the stress on the cable over a large area maximizing strength and lifetime. In particular the cable hanging system of the present invention distributes the force on the cable over an extended length of the cable. The entire system has rotational adjustability, separately adjustable from the support cable's own unlimited rotational adjustability, which prevents the cable's rotational tension from causing rotational kinking in both the clockwise and counterclockwise directions. In addition, this allows positioning of the cable to be moved on its own radius from the center of the system to allow fine tuning of the cable's position.

The cable hanging system of the present invention comprises a base, a first disk, a second disk, a first fastener, a second fastener, a third fastener and a steel cable. The base, first disk, and second disk have apertures that correspond to the first fastener, second fastener and third fastener that allow the first disk and the second disk to be attached to the base. The first disk has a circumferential channel that receives the steel cable therein. The first disk further has a cutout for the steel cable to exit the circumferential channel and be threaded between the first fastener and second fastener on the planar surface of the first disk. The steel cable is then strung over the second screw and in between the second screw and the third screw. The second disk is stacked on the first disk and sandwiches a portion of the cable between the first disk and second disk to secure the cable in place.

The base is rotatably attachable to a fixed location, either in the shaftway or on the elevator car, to allow adjustable positioning of the cable hanging system.

The cable of the present invention has a improved quality over those known in the prior art. The cable can support its full load as the cable is not stressed over a definite point along the cable typically found in current installations. In the present invention, using a cable having a ¼″ diameter which lays over nearly twenty-one (21) inches of the circumferential channel of the first disk, distributes the load evenly and maximizing its strength. Testing by Independent Testing Laboratories, Inc. of College Point, N.Y. has found such cable, having a ¼″ diameter, used with the present invention to have a breaking strength of more than 10,000 lbs and no slipping was detected during the test.

### BRIEF DESCRIPTION OF THE DRAWINGS

A preferred embodiment of the present invention has been chosen for purposes of illustration and description and is shown in the accompanying drawings forming a part of the specification wherein:

FIG. 1 is an elevational view of the cable hanging system of the present invention with a cable installed.

FIG. 2 is a front elevational view of the cable hanging system of the present invention displaying the first bottom disk with the second top disk removed with a cable installed.

FIG. 3 is a left side view of the present invention.

FIG. 4 is a left side view of the present invention displaying the first bottom disk with the second top disk removed.

FIG. 5 is a top plan view of the present invention.

FIG. 6 is a left side perspective view of FIG. 2.

FIG. 7 is a left side perspective view of FIG. 1.

FIG. 8 is an elevational view of a cable hanging system of a second embodiment of the present invention with a cable installed.

FIG. 9 is rear elevational view of the cable hanging system of a second embodiment of the present invention.

FIG. 10 is left side perspective view of FIG. 8.

FIG. 11 is an elevational view of a cable hanging system of the present invention having an alternative cable bracket with a cable installed.

FIG. 12 is an elevational view of the alternative cable bracket of the cable hanging system of the present invention with a cable installed.

FIG. 13 is an elevational view of the cable hanging system of the second embodiment of the present invention having a second alternative cable bracket with a cable installed.

FIG. 14 is an elevational view of the cable hanging system of the second embodiment of the present invention displaying the first bottom disk with the second top disk removed with a cable installed.

FIG. 15 is a elevational side view of the cable hanging system of the second embodiment of the present invention without the cable, second alternative cable bracket nor bracket retainer installed.

FIG. 16 is a side elevational view of the cable hanging system of the second embodiment of the present invention with the second alternative cable bracket and bracket retainer installed.

FIG. 17 is a left side perspective view of FIG. 15.

FIG. 18 is a left side perspective view of the cable hanging system of the second embodiment of the present invention with the cable, second alternative cable bracket and bracket retainer installed.

FIG. 19 is a left side perspective view of the secondary grip system of the cable hanging system of the second embodiment of the present invention.

### DETAILED DESCRIPTION OF THE PREFERRED EMBODIMENTS

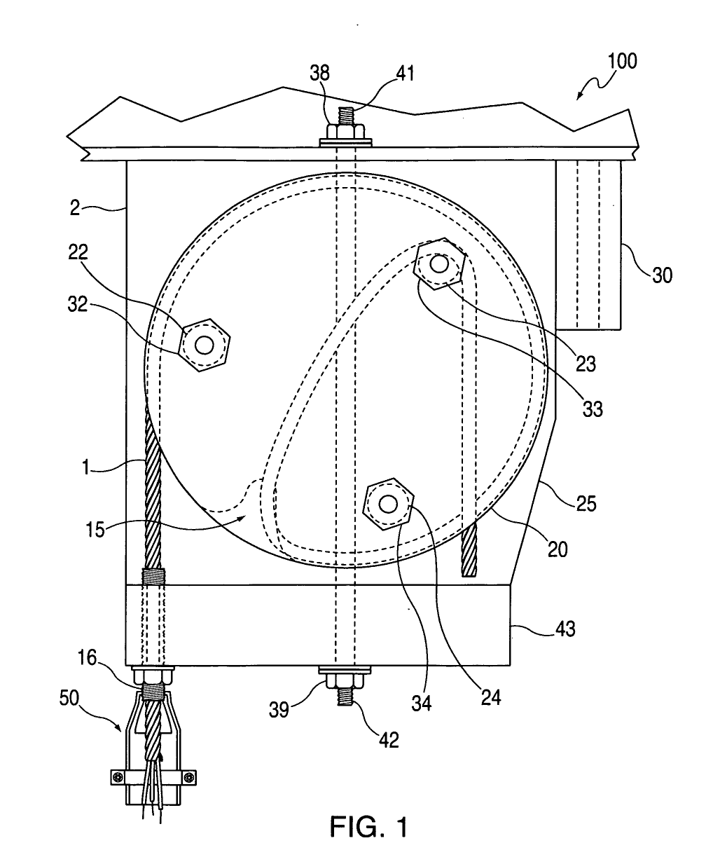

With reference to the drawings, wherein the same reference number indicates the same element throughout, there is shown in FIG. 1 a front elevational view of the cable hanging system 100 of the present invention. As shown in FIG. 1, the cable hanging system 100 includes a base 2, a first disk 10 (not shown), a second disk 20, a first pin 12, second pin 13, and a third pin 14.

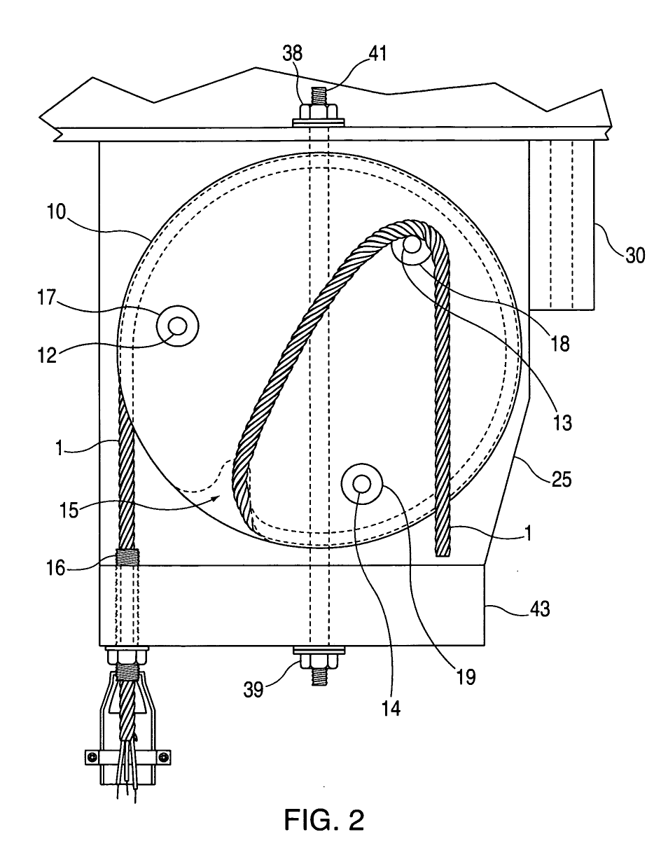

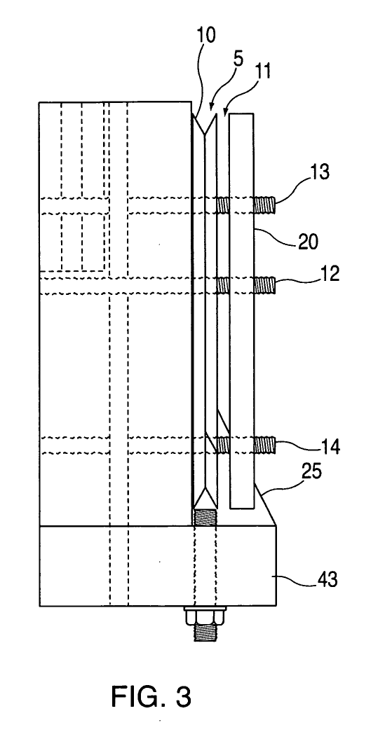

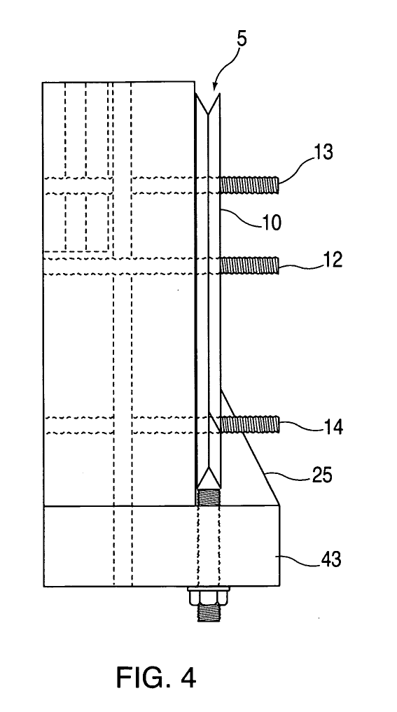

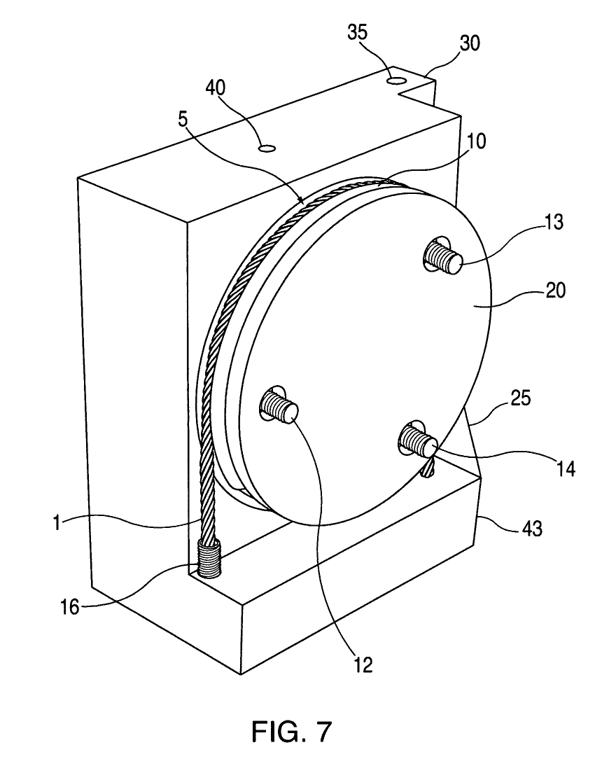

As shown in FIGS. 1-7, first disk 10 has a first aperture 22, second aperture 23 and third aperture 24. First disk 10 has a circumferential channel 5 that receives steel cable 1. The channel 5 has a v-shape cross-section such that the steel cable 1 receives therein is securely and frictionally wedged in the channel 5. The v-shaped channel 5 advantageously is capable of receiving different gauge cables. As shown in FIG. 2, first disk 10 has a cutout 15 that allows steel cable 1 to exit the circumferential channel 5. Second disk 20 has a first aperture 22, second aperture 23 and third aperture 24 that correspond to first aperture 17, second aperture 18 and third aperture 19, respectively, of first disk 10.

As shown in FIGS. 1-7, base 2 has a ledge 43. Ledge 43 has a first aperture 45 there through. Aperture 45 receives a fastener 16 there through. Fastener 16 is tubular to allow for cable 1 to be attached there through. Base 2 has first aperture 46, second aperture 47 and third aperture 48 that correspond to the three apertures of the first disk 17, 18 and 19 and second disk 22, 23 and 24. First pin 12 engages first apertures of first disk 10 and second disk 20 and threadingly engages the first aperture 46 of base 2. The second pin 13 engages the second apertures 18, 23 of the first disk 10 and the second disk 20 and threadingly engages the second aperture 47 of base 2. The third pin 14 engages the third apertures 17, 24 of the first disk 10 and the second disk 20 and threadingly engages the third aperture 48 of base 2. Base 2 has a second aperture 40 that can receive a fastener 41 for mounting the cable hanging system 100 to a fixed location either in the shaft way or on the elevator car. Fastener 41 shown in FIG. 1 comprises one threaded pin and two nuts 38, 39. Base 2 has an extension 30 that has aperture 35 there through.

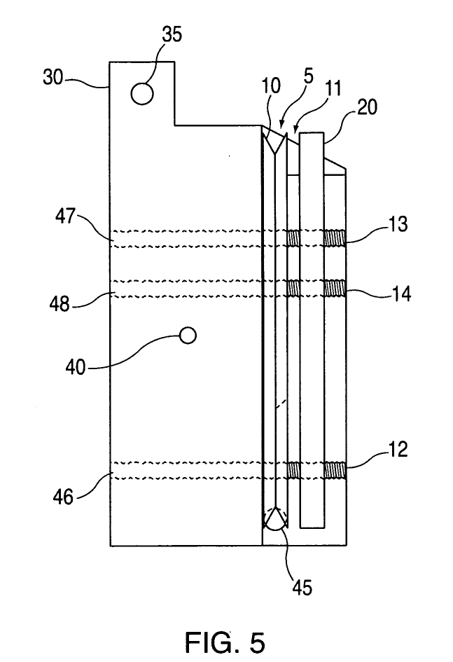

As shown in FIG. 5, the cable hanging system 100 is assembled as follows. First pin 12, second pin 13 and third pin 14 are threaded through first aperture 46, second aperture 47 and third aperture 48 in base 2, respectively. First disk 10 is secured to base 2 with first pin 12, second pin 13 and third pin 14 being inserted into first aperture 17, second aperture 18, third aperture 19, respectively. First disk 10 lays flushed with base 2.

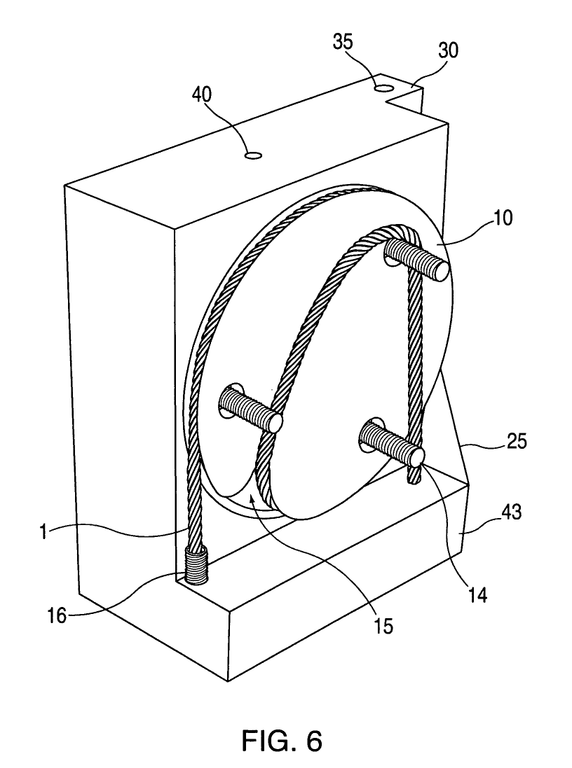

Steel cable 1 has a first end and a second end. The second end of steel cable 1 is held by a clamp portion 50 mounted on tubular fastener 16 to support the multi conductor electrical cables 60 which are wrapped around and supported by the steel cable 1. The cable hanging system 100 engages and secures the steel cable 1. The first end of steel cable 1 is received through fastener 16. Fastener 16 may be a tubular threaded screw. Fastener 16 is received through aperture 45 of ledge 43. Clamp portion 50 is threadingly mounted on fastener 16 and has two downwardly extending arms. Near the distal ends of these arms is a pair of releasably connected clamp members that secure and support the multi conductor electrical cables 60 wrapped around the steel cable 1. As shown in FIG. 6, steel cable 1 is wedged in the v-shaped circumferential channel 5 of first disk 10. Steel cable 1 extends around the circumference of first disk 10 within channel 5 approximately 270 degrees around first disk 10 to the location of the cutout 15 of first disk 10. Steel cable 1 follows from channel 5 through cutout 15 of first disk 10 to exit the channel 5. The first end of steel cable 1 is positioned between first pin 12 and second pin 13, over the top of second pin 13 and back down between second pin 13 and third pin 14 on the planar surface of first disk 10. The first end of steel cable 1 hangs below first disk 10.

Second disk 20 is stacked on top of the first disk 10 by inserting first pin 12, second pin 13 and third pin 14 into first aperture 22, second aperture 23, third aperture 24, respectively. The steel cable 1 is sandwiched between the first and second disks 10 and 20. Second disk 20 is secured to the first disk 10 and base 2 by first nut 33, second nut 34 and third nut 35 on first pin 12, second pin 13 and third pin 14, respectively.

In a preferred embodiment of the present invention base 2, first disk 10 and second disk 20 are made from aluminum.

As the length of the steel cable 1 wound around the cable hanging system 100 is longer than prior art systems, the force is distributed over the longer length.

The cable hanging system is mounted to a fixed location in the shaft way or elevator car with a pin 41 and nut 38. Extension 30 of base 2 is used to fix the position of the cable mounting system 100 to the shaft way or elevator car. A pin (not shown) may be inserted into aperture 35 and secured with a nut (not shown). This allows for the entire cable mounting system 100 to be freely rotationally adjustable around the axis of pin 41 and restricted from rotational movement by nut inserted thru aperture 35. Therefore, the cable's rotational tension may be coordinated to prevent rotational kinking in both the clockwise and counterclockwise directions.

While first, second and third pins 12, 13 and 14 are shown as threaded pins, other prior art fasteners such as nut and bold combination can be used. In addition first, second and third pins 12, 13 and 14 may be prefabricated to be attached to base 2. Further first, second and third pins 12, 13 and 14 may be partially threaded to allow for securing by a nut.

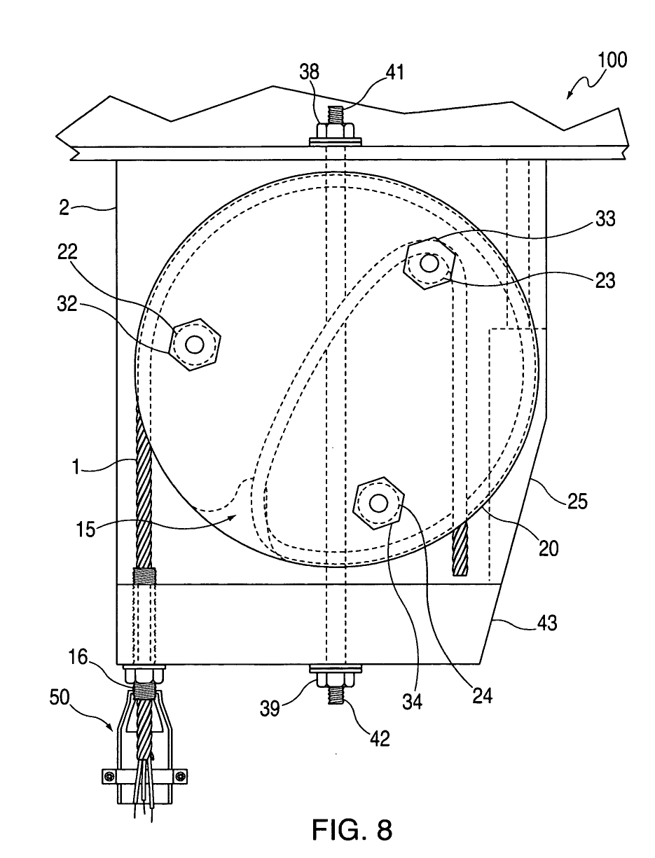

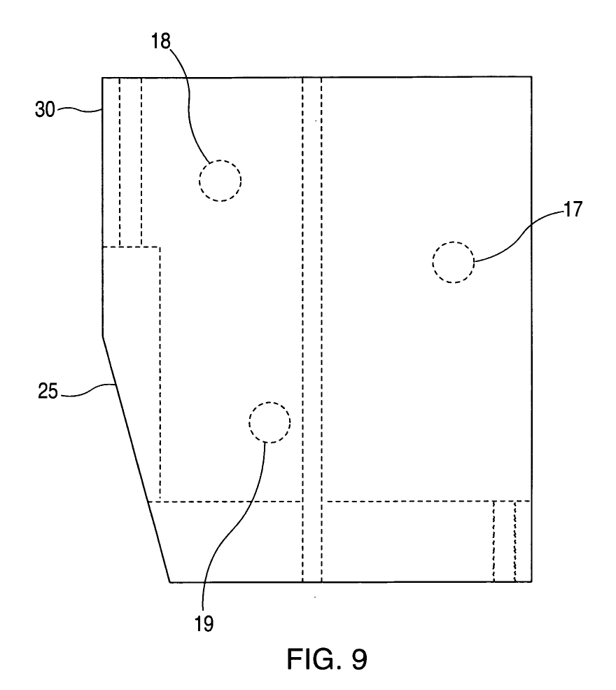

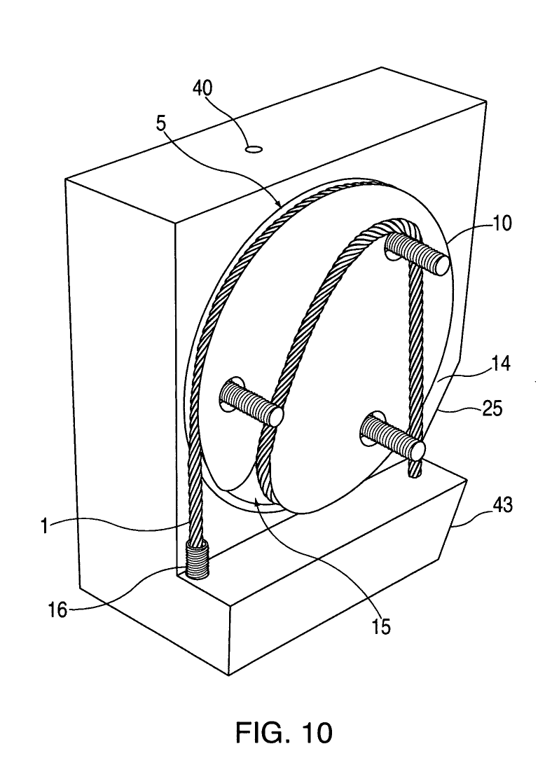

FIGS. 8-10 show a second embodiment of the present invention. With the extension 30 of base 2 extending from the rear of base 2.

In the second embodiment of the present invention, cutout 25 of base 2 extends through ledge 43. As the cable mounting system 100 is rotationally adjustable, cutout 25 provides clearance for cable 1 while the cable mounting system 100 is being adjusted.

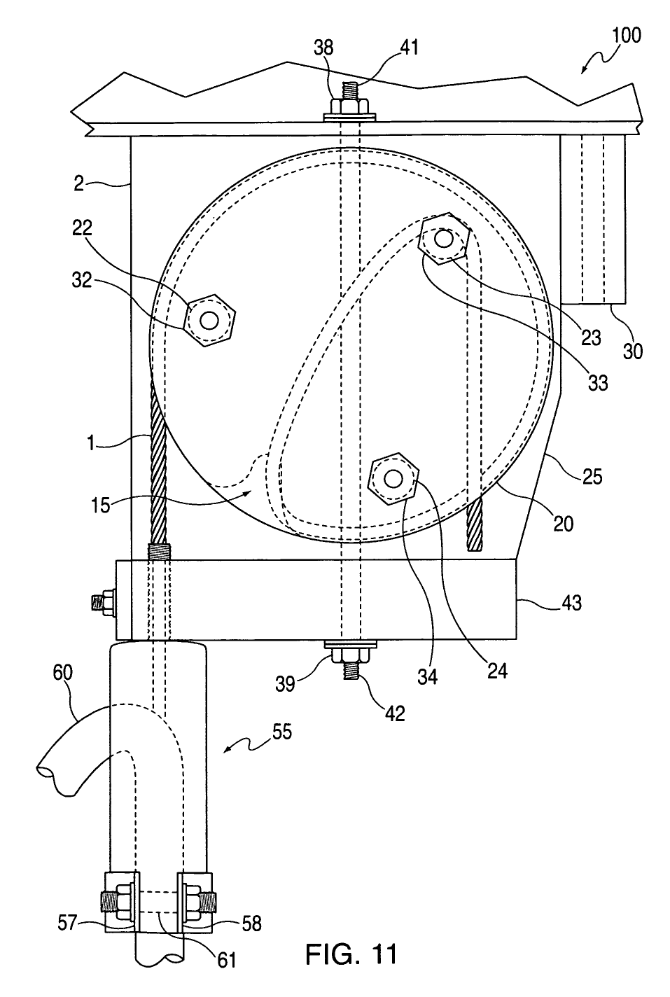

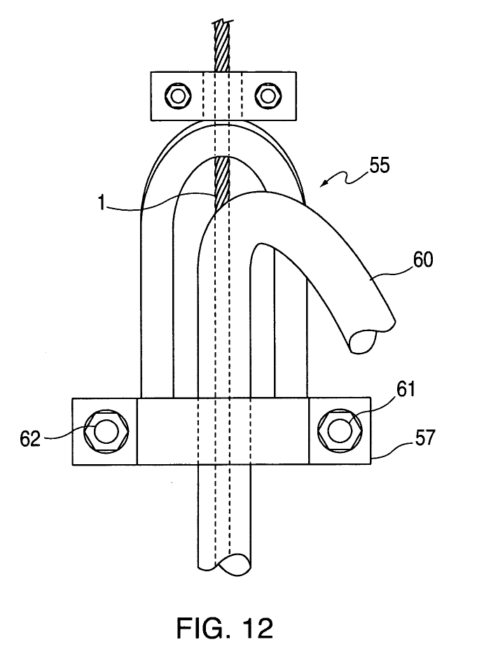

FIGS. 11-12 show the cable mounting system 100 having an alternative cable bracket 55 for supporting the multi conductor electrical cable attached to the second end of steel cable 1. Cable bracket 55 is rotationally mounted to ledge 43. The alternative cable bracket 55 has a base 56, a first clamp member 57 and a second clamp member 58. Bracket 55 has a tubular and partially open portion for cradling the multi conductor electrical cable 60. The first clamp member 57 and the second clamp member 58 are releasably connected to each other by a first fastener 61 and a second fastener 62 to clamp the multi conductor electrical cable 60 within the tubular portion. The first and second clamp members 57 and 58 cannot be over tightened to damage the multi conductor electrical cable because they are restricted from doing so by the tubular portion.

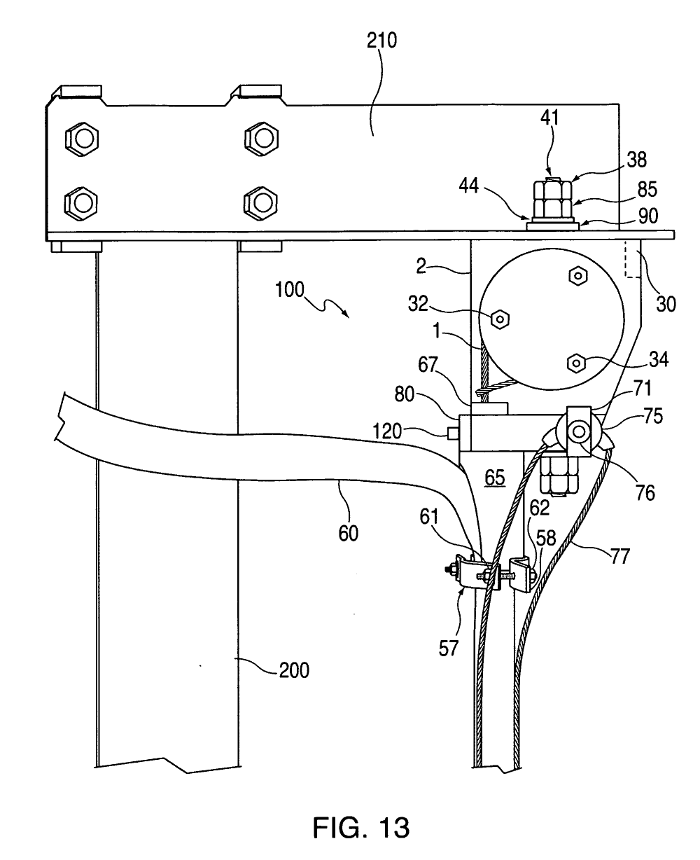

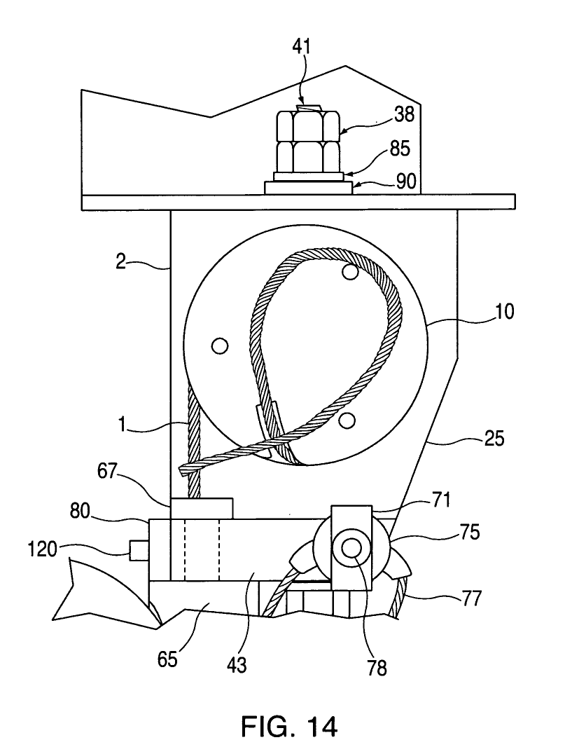

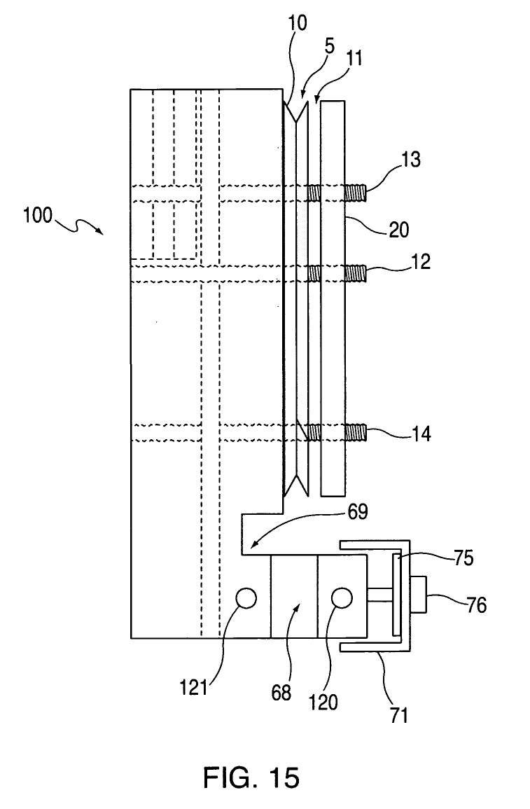

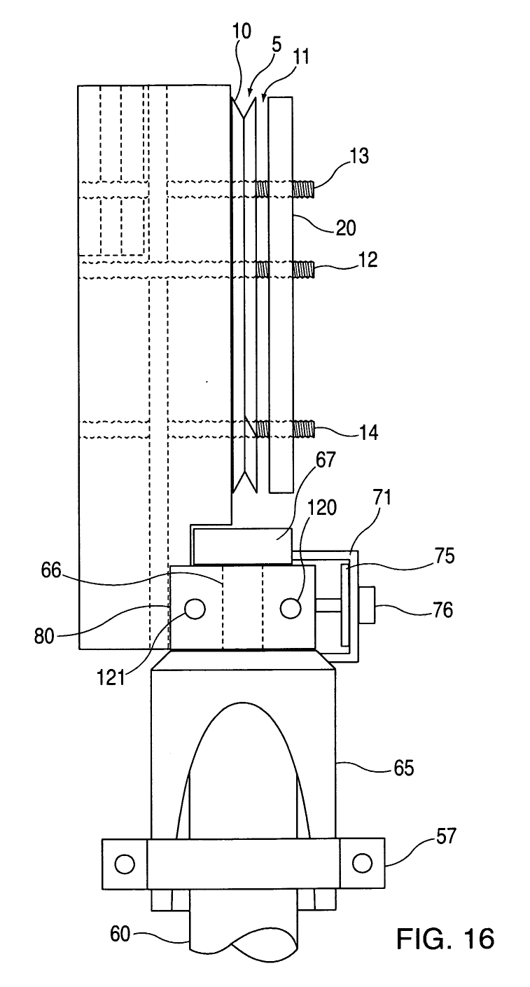

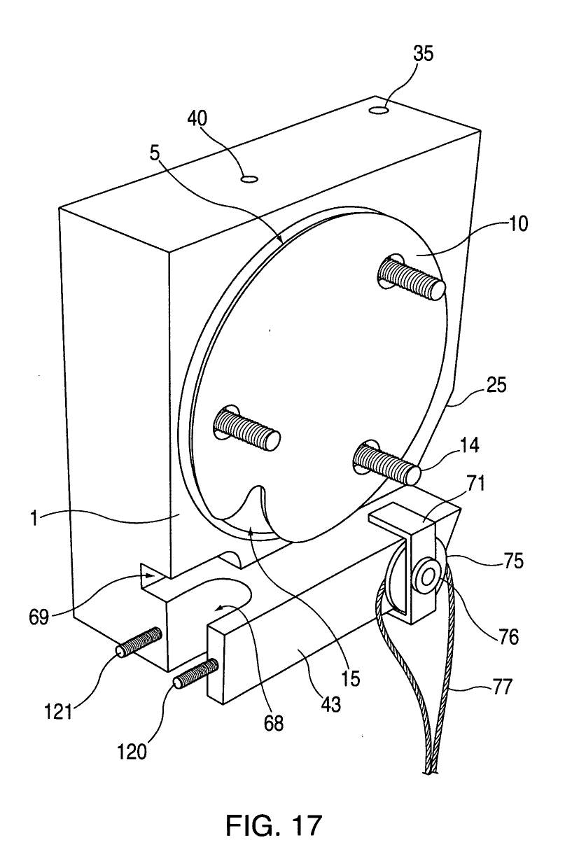

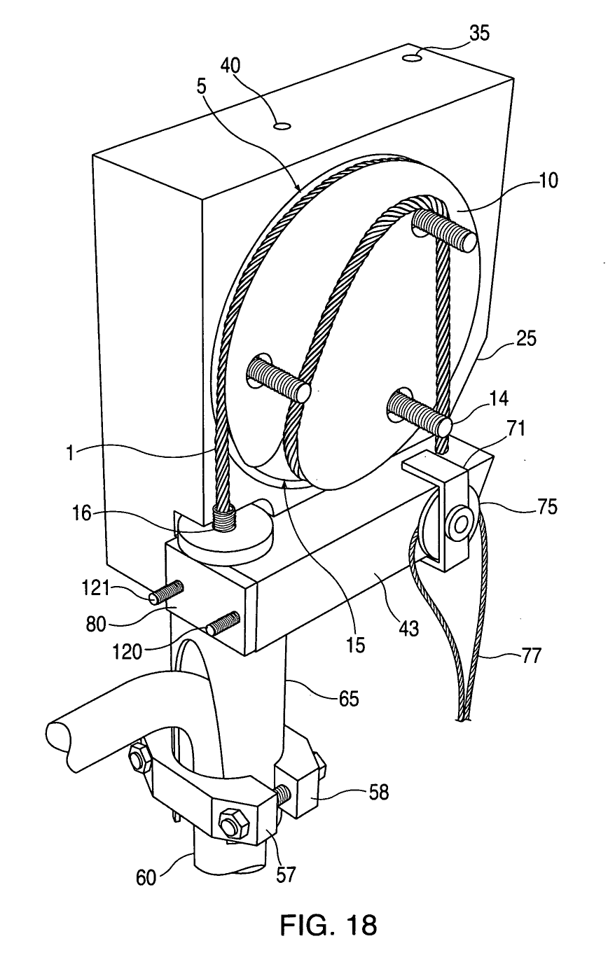

FIGS. 13-18 show the cable mounting system 100 having a second alternative cable bracket 65 for supporting the multi conductor electrical cable 60 attached to the second end of steel cable 1. Second alternative cable bracket 65 has a neck portion 66 and head portion 67. Cable bracket 65 is mounted to base 2 by sliding the neck portion 66 into a notch opening 68 in ledge 43. The head portion 67 nests within a second notch opening 69 in base 2. The second alternative cable bracket 65 is secured by bracket retainer 80. Bracket retainer 80 is releasable connected to ledge 43 by a first fastener 120 and a second fastener 121. The second alternative cable bracket 65 has a first clamp member 57 and a second clamp member 58. Bracket 65 has a tubular and partially open portion for cradling the multi conductor electrical cable 60. The first clamp member 57 and the second clamp member 58 are releasably connected to each other by a first fastener 61 and a second fastener 62 to clamp the multi conductor electrical cable 60 within the tubular portion. The first and second clamp members 57 and 58 cannot be over tightened to damage the multi conductor electrical cable because they are restricted from doing so by the tubular portion.

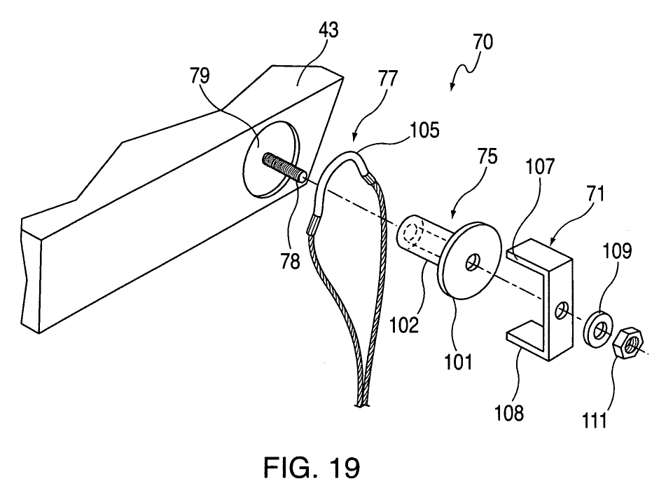

FIGS. 13-19 show the cable mounting system 100 having a secondary grip system 70 having a grip retainer bracket 71, grip support ring 75, grip wire 77, and fastener 78. The grip support ring 75 has a head 101, a long tubular section 102 and an aperture therethrough. The grip wire 77 contains a mount portion 105. The grip retainer bracket 71 has a first arm 107 and a second arm 108. The grip system 70 is mounted to the ledge 43 at cutout 79 and with fastener 78. The fastener 78 axially engages the aperture of the grip support ring 75 with the long tubular section 102 nesting within cutout 79. The mount portion 105 of the grip wire 77 rests on the long tubular section 102 of the grip support ring 75. Then the grip retainer bracket 71 axially engages the fastener 78, thereby causing first arm 107 and second arm 108 to fit over each side of head 101 of the grip support ring 75 thereby fixing the mount portion 105 of the grip wire 77.

As shown in FIG. 13, the cable hanging system 100 may be mounted at the top of an elevator shaft and/or at the halfway point of the elevator shaft. The main rail 200 may be used alone or the mounting bracket 210 is mounted to the main rail 200. Sufficient loop of multi conductor electrical cable 60 (approximately 6-18 inches) must be left for future rotational adjustments. Wiring is to be run to the controller as code allows.

The mounting of travel cables utilizing the system of the present invention may be established as follows. The mounting location must be capable of supporting the traveling cable(s) and all its loads, such as building steel, and is known to one skilled in the art. In order to utilize the full features of the cable hanging system 100 the mounting surface needs to be at least 5 inches in width with a ¾ inch mounting hole located in the center or if larger surface is used the mounting hole needs to be at least 2.5 inches from the edge of the steel so that the set screw will be functional. To have full adjustability of the cable hanging system 100, 5 inches of clearance should be left around the ¾ inch fastener 41. Then base 2 is to be secured to the mounting bracket 210 by fastener 41, flat washer 85, lock washer 44, first nut 38 and second nut 42. The second nut 42 should remain loose until final adjustment is made. The multi electrical cable 60 must be stripped to expose cable 1, trim sheath neatly around perimeter where it will be clamped. Retain 36 inches of cable 1 that is stripped clean at clamping end. Insert cable 1 through hole at the top of the second alternative cable bracket 65. Install first clamp 57 and second clamp 58 on the multi conductor electrical cable 60. Do not tighten at this point. The clamps used must correspond to the diameter of the multi conductor electrical cable 60.

The multi conductor electrical cable 60 is held under the second alternative cable bracket 65 and a minimum of 1.5 inches of the intact sheath of the multi conductor electrical cable 60 and is clamped above the first clamp 57 and second clamp 58. Pull cable 1 snugly into the channel 5 of the first disk 10 and around first disk 10 and through the cutout 15. Cable 1 is then strung up between first pin 12 and second pin 13, over second pin 13 and back between second pin 13 and third pin 14. Then pull cable 1 tight. Second disk 20 is installed using a first ⅜ flat washer (not shown), second ⅜ flat washer (not shown), third ⅜ flat washer (not shown), first lock washer (not shown), second lock washer (not shown), third lock washer (not shown) and first nut 32, second nut 33 and third nut 34. Tighten to 40 ft-lb. Multi conductor electrical cable 60 is then run down the shaft and under the elevator. Measure multi conductor electrical cable 60 for a proper loop and mark multi conductor electrical cable 60 allowing sufficient cab wiring. Strip multi conductor electrical cable 60 at the mark and repeat mounting for second cable hanging system 100 under elevator cab.

If necessary, rotate base 2 around axis of pin 41 so that the multi conductor electrical cable 60 hangs freely in the shaft way clear of any obstructions during normal operations. Using two cable hanging systems 100 properly mounted at each end of multi conductor electrical cables 60 the installer has up to 14 inches of cable position adjustment range. Once final position is found, the first ¾ inch bolt nut may be tightened to 120 ft-lb. Then the upper and lower lock nuts are to be tightened to 100 ft-lb. After the ¾ nuts are securely tightened, the set bolt prevents additional rotation. Tighten first clamp 57 and second clamp 58 until the tips of the clamps touch each other on each side of the second alternative cable bracket 65. This secures the multi conductor electrical cable 60 firmly in the second alternative cable bracket 65 allowing rotational adjustments and minimizing possible damages to the conductors. If necessary, make minor adjustments to rotate the second alternative cable bracket 65 so the multi conductor electrical cable 60 hangs properly. Then tighten the bracket retainer 80 to secure second alternative cable bracket 65. Route stripped conductors to their proper location leaving at least 6-18 inch loop of multi conductor electrical cable 60 for future adjustments.

The secondary grip system 70 is located on the ledge 43 of the base 2. Remove the grip retainer bracket 71 and place the grip wire 77 on the grip support ring 75. Reinstall the grip retainer bracket 71, flat washer 109, lock washer 111 and torque nut to 20 ft-lb. The ends of the grip wire 77 secure to the multi conductor electrical cable 60 below the first clamp 57 and the second clamp 58 to provide additional support to the multi conductor electrical cable 60. The connection of the grip wire 77 to the multi conductor electrical cable 60 acts as a Chinese finger trap such that when pressure is applied to each end of the grip wire 77, as it holds the multi conductor electrical cable 60, its grip tightens.

The features of the invention illustrated and described herein are the preferred embodiments. Therefore, it is understood that the appended claims are intended to cover unforeseeable embodiments with insubstantial differences that are within the spirit of the claims.

What I claim is:

1. A device for hanging to a fixed position a plurality of electrical conductors bundled to a cable having opposite ends, comprising:
a base adapted to be removeably attached to the fixed location;
a first plate having a perimeter with means for engaging one of said ends of said cable; and
means for attaching said base to said first plate.

2. The device of claim 1 wherein said engaging means comprises a channel around said perimeter of said first plate.

3. The device of claim 2 wherein said channel has a v-shaped cross-section.

4. The device of claim 2 wherein said first plate further comprises a cutout for said cable to exit said channel.

5. The device of claim 1 further comprising a second plate and means for attaching said second plate to said first plate.

6. The device of claim 5 wherein said means for attaching said base to said first plate and said second plate to said first plate comprises:
a first aperture, a second aperture and a third aperture on each of said base, first plate and second plate;
a first fastener correspondingly engages said first aperture of said base, said first aperture of said first plate and said first aperture of said second plate;
a second fastener correspondingly engages said second aperture of said base, said second aperture of said first plate and said first aperture of said second plate; and
a third fastener correspondingly engages said third aperture of said base, said third aperture of said first plate and said first aperture of said second plate.

7. The device of claim 1 wherein the device is made of aluminum.

8. A method of installing to a fixed location a plurality of electrical conductors bundled to a cable having opposite ends, said method comprising:
a) providing a base;
b) providing a first plate having a circumferential channel and a cutout;
c) providing a second plate;
d) providing a first fastener for attaching said base, first plate and second plate together;
e) providing a second fastener for attaching said base, first plate and second plate together;
f) providing a third fastener for attaching said base, first plate and second plate together;
g) placing and engaging one end of said cable around the channel of said first plate;
h) running said one end of said cable through said cutout of said first plate and around said first fastener, said second fastener and said third fastener;
i) attaching said second plate to said first plate to secure said one end of said cable; and
j) tightening said first fastener, second fastener and said third fastener to secure said base, first plate and second plate together and securing said one end of said cable.

9. The method of claim 8, wherein:
said channel has a v-shaped cross section.

10. An elevator cable hanger, comprising:
a base having a first aperture, a second aperture and a third aperture;
a first plate having a first aperture, a second aperture and a third aperture that correspond to said first aperture of said base, said second aperture of said base, and said third aperture of said base, a circumferential channel and a cutout;
a second plate having a first aperture, a second aperture and a third aperture that correspond to said first aperture of said first plate, said second aperture of said first plate and said third aperture of said first plate;
first, second and third fasteners for attaching said base, first plate and said second plate together;
said first fastener correspondingly engages said first aperture of said base, said first aperture of said first plate, and said first aperture of said second plate;
said second fastener correspondingly engages said second aperture of said base, said second aperture of said first plate, and said second aperture of said second plate; and
said third fastener correspondingly engages said third aperture of said base, said third aperture of said first plate, and said third aperture of said second plate.

11. The hanger of claim 10 wherein said channel has a v-shaped cross-section.

12. The device of claim 1 wherein said base is adapted to be rotatably attached to the fixed location.

13. The device of claim 1 wherein said base having a first opening and further comprises a first fastener for adaptedly securing said base to said fixed location through said first opening.

14. The device of claim 13 wherein said base having a second opening and further comprises a second fastener for adaptedly securing said base to said fixed location through said second opening to prevent rotation of said base relative to said fixed location.

15. The device of claim 13 wherein said base having a tapered body that allows rotation of said base around the axis of the first fastener with respect to said fixed location without interfering with the cable being hung on said device.

16. The device of claim 1 further comprising a bracket for supporting the cable being hung on said device.

17. The device of claim 16 wherein said bracket having a tubular body with an opening.

18. The device of claim 17 wherein said bracket further comprises a first clamp member and a second clamp member.

19. The device of claim 18 wherein said first clamp member is releaseably attached to said second clamp member.

20. The device of claim 1 wherein said means for attaching said base to said first plate is integral with said base.
